(19) United States
(12) Patent Application Publication
(10) Pub. No.: US 2020/0391062 A1
(43) Pub. Date: Dec. 17, 2020

(54) APPARATUS FOR MIXING AND APPLYING PARTICULATE MATTER AND FOAM

(71) Applicant: Rusmar Incorporated, West Chester, PA (US)

(72) Inventor: Daniel Miller, Johnstown, PA (US)

(73) Assignee: Rusmar Incorporated, West Chester, PA (US)

(21) Appl. No.: 16/437,152

(22) Filed: Jun. 11, 2019

(51) Int. Cl. A62C 31/28; A62C 31/12; B05B 7/00; B05B 7/14

(52) U.S. Cl. CPC A62C 31/28; B05B 7/1404; B05B 7/0031; A62C 31/12

(57) ABSTRACT

In an apparatus for applying rock dust with foam to a mine wall to suppress mine fires and prevent explosions, foam and air-entrained rock dust are separately conveyed to a combination nozzle and mixing device. The air-entrained rock dust moves axially through a passage into an enlarged chamber while foam moves through an array of openings surrounding the passage that direct the foam in a helical path. The helical movement of the foam, and the reduction of the velocity of the air-entrained rock dust resulting from its movement into the enlarged chamber, enhance mixing. The mixture passes from the enlarged chamber through a restricted nozzle to increase the velocity of the mixture for effective spraying. The restricted nozzle has an array of internal flow-interrupting baffles that further promote mixing by generating turbulence, condense the stream, and shape the spray pattern.

### FIELD OF THE INVENTION

This invention relates to an apparatus for use in producing a mixture of foam and particulate matter and for applying the mixture to a surface. The nozzle can be used, for example, for the application of a mixture of foam and rock dust to a mine wall for the purpose of suppressing mine fires and preventing explosions.

### BACKGROUND OF THE INVENTION

In coal mining, it has been common practice to apply limestone in the form of a dust to the walls of a mine, thereby causing the limestone to adhere to the walls. The process, known as “rock dusting,” has two effects. First, because the limestone dust covers exposed surfaces of unmined coal, it prevents mine fires from being propagated along those exposed surfaces. Second, if methane, coal dust, or a mixture of methane and coal dust, ignite in a mine causing an explosion, the rock dust adhering to the mine wall will become airborne, and suppresses the propagation of fire resulting from the explosion. The airborne rock dust also absorbs the heat from the explosion, cools the gases and extinguishes the explosion. The key to this process is to have the rock dust particles release from the roof, bottom and ribs of the mine in particles fine enough to be suspended in the air.

The United States Mine Safety and Health Administration has established standards for rock dusting, which include a requirement that all exposed surfaces of a mine be covered with rock dust at least 80% of the content of which is non-combustible.

In recent years, mines have been using chemical foam to achieve improved adhesion of the rock dust to mine surfaces. One method of using foam in rock dust application is to apply a dry mixture of rock dust and a foaming agent to a mine wall. Another method is to apply a mixture of foam and rock dust to a mine wall. In the last-mentioned method, the foam is formed, mixed with rock dust in a mixing vessel, and pumped through a conduit to the point of application. A system for utilizing foam to enhance the adhesion of rock dust to a mine wall is described in U.S. Pat. No. 6,726,849, granted Apr. 27, 2004. U.S. Pat. No. 10,071,269, granted Sep. 11, 2018, describes an apparatus for applying rock dust to a mine wall that utilizes first and second elongated and flexible conduits. Rock dust is entrained in air in the first conduit, and a flowable foam, made by mixing a foamable liquid and air, is delivering through the second conduit. Rock dust and air taken from the first conduit are combined with flowable foam taken from the second conduit by a Y-joint in a portable, typically hand-held, assembly that includes a nozzle. The combined mixture of air, rock dust and foam is applied by the nozzle to a mine wall. The apparatus in U.S. Pat. No. 10,071,269 has the ability to combine rock dust and foam near the point of application to the mine wall, allowing the foam to travel to the mixing device and low pressure and at a low velocity while the rock dust travels to the mixing device at a high velocity. The low pressure and low velocity of the foam avoids deterioration of foam that takes place when a foam travels through a long conduit along with rock dust. The high velocity of the rock dust avoids clogging and inconsistent flow.

While the combination of foam and rock dust adjacent the point of application has the advantage of avoiding deterioration of the foam, it has a disadvantage in that it allows for some release of airborne dust in the process of applying the rock dust to the mine wall.

Another approach to rock dust application is described in U.S. Pat. No. 9,228,435, granted Jan. 5, 2016. In the method and apparatus described in U.S. Pat. No. 9,228,435, water is used to carry the rock dust to the nozzle. The use of water is effective in eliminating airborne rock dust in the application process. But, as mentioned above, it is important to have the rock dust particles release from the roof, bottom and ribs of the mine in particles fine enough to be suspended in air. A problem with using water with rock dust is clumping. When water mixes with rock dust, the particles tend to stick together, much like concrete that absorbs moisture from the air, and are less effective in suppressing an explosion. Thus, there remains a need for reduction of airborne dust particles in an apparatus in which the rock dust is conveyed to a portable mixing and application device in air.

### SUMMARY OF THE INVENTION

The principal object of this invention is to provide an apparatus in which foam and particulate matter in a stream of air are separately conveyed to a combination nozzle and mixing device and combined in such a way that the particulate matter is more fully absorbed into the foam, thereby reducing and substantially eliminating airborne dust particles.

Briefly, the apparatus allows foam to be generated remotely and conveyed through a hose at a low pressure, low velocity, thus maintaining the integrity of the foam. The pulverized limestone dust is conveyed at high velocity to reduce clogging and inconsistent flow, through a separate hose, and is introduced to the foam in the apparatus near the point of application, thus reducing cleanup while simultaneously reducing airborne dust and creating a homogenous mixture to be applied to the mine wall.

As the low pressure, low velocity, foam is introduced to the high velocity pulverized limestone dust, the foam, and the air-entrained limestone dust proceed into a larger diameter chamber, allowing the dust and air mixture to expand, while its velocity decreases and more closely matches the velocity of the foam. This promotes the absorption of the pulverized limestone into the foam. The resulting mixture then proceeds through a converging section to increase velocity for propulsion onto the mine wall. As it passes through the converging section, the mixture moves through a tubular nozzle of uniform cross-section that includes interrupters that are placed in a helical pattern inside the tubular nozzle and protrude into the flowing stream of foam, air and limestone dust. The interrupters cause turbulence in the stream, promote final mixing, condense the stream, and shape the spray pattern of the mixture for application.

The invention has potential applications for applying mixtures of foam and particulate matter in contexts other than mine wall dusting. Thus, in more general terms, the invention is an apparatus for mixing a foam with particulate matter and air to produce a mixture, and for spraying the mixture. The apparatus comprises an elongated passage extending along a longitudinal axis. The passage has a first inlet opening at one end thereof, facing along the direction of the longitudinal axis, for receiving a stream of air and particulate matter passing through the first inlet opening in the direction of the longitudinal axis. The passage has an outlet opening at an opposite end thereof for spraying the mixture. A second inlet opening faces in a direction transverse to the longitudinal axis for receiving a stream of flowable foam directed through the second inlet opening toward the longitudinal axis. A ring adjacent the first inlet opening has a central opening forming a part of the elongated passage, and an annular channel on the exterior of the ring, the channel being positioned to receive flowable foam passing through the second inlet opening. The ring also has a circular flange extending around the ring and forming a boundary of the annular channel on the side thereof closer to the outlet opening. The ridge has passages for the movement of flowable foam from the annular channel into the elongated passage for admixture with air and particulate matter passing though the central opening of the ring.

The elongated passage comprises a chamber located on the side of the ring remote from the first inlet opening, and a tubular portion extending from the chamber to the outlet opening. The chamber, which can be, but is not necessarily, in the form of a cylindrical tube, has a maximum cross-sectional area transverse to the longitudinal axis larger than the maximum cross-sectional area of the central opening of the ring. The larger cross-sectional area of the chamber reduces the velocity of the stream of air and particulate matter as it passes from the central opening of the ring into the chamber, and consequently more complete mixing of foam with air and particulate matter can take place in the chamber. The cross-sectional area transverse to the longitudinal axis of at least a portion of the length of the tubular portion is smaller than the maximum cross-sectional area of the chamber. Thus, the velocity of a mixture of foam, air and particulate matter through the outlet opening exceeds the maximum velocity of the mixture of foam, air and particulate matter flowing through the chamber.

The passages in the ridge are preferably constituted by a plurality of circumferentially distributed through holes skewed in relation to the longitudinal axis in directions to cause foam exiting from the through holes to flow in a helical pattern. Each of these holes has an inlet end for receiving foam from the annular channel and an outlet end for delivery of foam to the chamber. The outlet end of each of these holes is preferably closer than its inlet end to the longitudinal axis of the apparatus.

In a preferred embodiment of the invention, the tubular portion extending from the chamber to the outlet opening includes a plurality of flow-interrupting baffles for promoting turbulence in the flow of the mixture through the tubular portion. The flow interrupting baffles may extend inward from the inner wall of the tubular portion. These flow-interrupting baffles preferably extend inward from the inner wall from locations on an imaginary helix on the cylindrical inner wall of the tubular portion, and each of the baffles is preferably in the form of a twisted plate secured to the inner wall by a fastener, and extends obliquely from the location of the fastener toward the axis and toward the outlet opening.

### BRIEF DESCRIPTION OF THE DRAWINGS

FIG. 1 is a perspective view of the mixing and applying device in accordance with the invention;

FIG. 2 is a first longitudinal cross-sectional view of the mixing and applying apparatus, taken on a first longitudinal section plane;

FIG. 3 is another longitudinal cross-sectional view of the mixing and applying apparatus, taken on a second section plane perpendicular to the first section plane;

FIG. 4 is an elevational view showing the outlet end the mixing and applying apparatus;

FIG. 5 is an elevational view showing details of a ring, at the inlet end of the apparatus, having multiple foam passages for directing foam into a mixing chamber in which the foam is combined with rock dust that passes through a central opening in the ring;

FIG. 6 is an elevational view of ring as seen from the right side of FIG. 5; and

FIG. 7 is a partial elevational view of the right side of the ring in FIG. 5, illustrating the configuration of the foam passages.

### DETAILED DESCRIPTION OF THE PREFERRED EMBODIMENTS

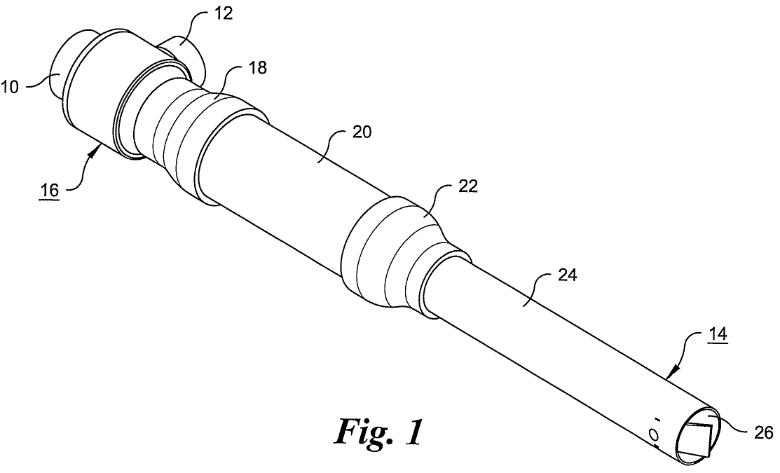

The apparatus in accordance with the invention can be in the form of a hand-held assembly as shown in FIG. 1, comprising an inlet 10 for connection to a first flexible hose for carrying particulate matter, e.g., limestone dust entrained in air, an inlet 12 for connection to a second flexible hose for carrying foam, and a nozzle 14 for directing the mixture of air, particulate matter, and foam at a surface, such as the wall of a coal mine.

The flexible hoses connect respectively a remote source for combining air and particulate matter and a remote foam generator. The remote source for combining air and particulate matter can be, for example, a rock dust system as described in U.S. Pat. No. 10,071,269, and the foam generator can be the foam/air mixing device described in the same patent. The disclosure of U.S. Pat. No. 10,071,269 is here incorporated by reference.

The flexible hoses allow the assembly of FIG. 1 to be carried by an individual, who can aim the nozzle at a desired target area on a mine wall or other surface. As an alternative, the apparatus can be transported and aimed toward a target area by mechanical means such as a remotely controlled boom on a vehicle or by a robotic carrying apparatus.

The apparatus includes a combining section 16 for bringing the foam introduced through the foam inlet 12 into contact with the air-entrained particulate matter introduced through inlet 10. The air which entrains the particulate matter necessarily flows into the inlet 10 at a high velocity, whereas the foam flows more slowly. The foam, particulate matter, and air move from the combining section 16, through an expansion section 18 into a chamber 20. having a diameter larger than that of the opening of inlet 10. In the chamber 20, expansion of the air reduces its velocity to a level more closely approaching the velocity of the foam so that thorough mixing takes place, i.e., substantially all of the particulate matter is absorbed into the foam.

Because of the reduction in velocity in the chamber 20, the mixture cannot be propelled directly from the chamber 20 toward a target surface. However, the chamber 20 is followed by a reduction section 22 and a the nozzle 14, which is in the form of a tubular section 24 having an internal diameter substantially smaller than that of chamber 20, e.g., a diameter comparable to that of the opening of the inlet 10 through which air-entrained particulate matter passes into the apparatus. The velocity of the mixture thus increases, and the mixture can be propelled from nozzle opening 26 toward a target area, which can be at a considerable distance from the apparatus. A typical rate of flow of the air entering the apparatus is in the range from approximately 75 to 100 cfm, and the pressure is typically approximately 10 psi. Under those conditions, the mixture exiting the nozzle opening 26 can be sprayed through a distance of approximately eight meters.

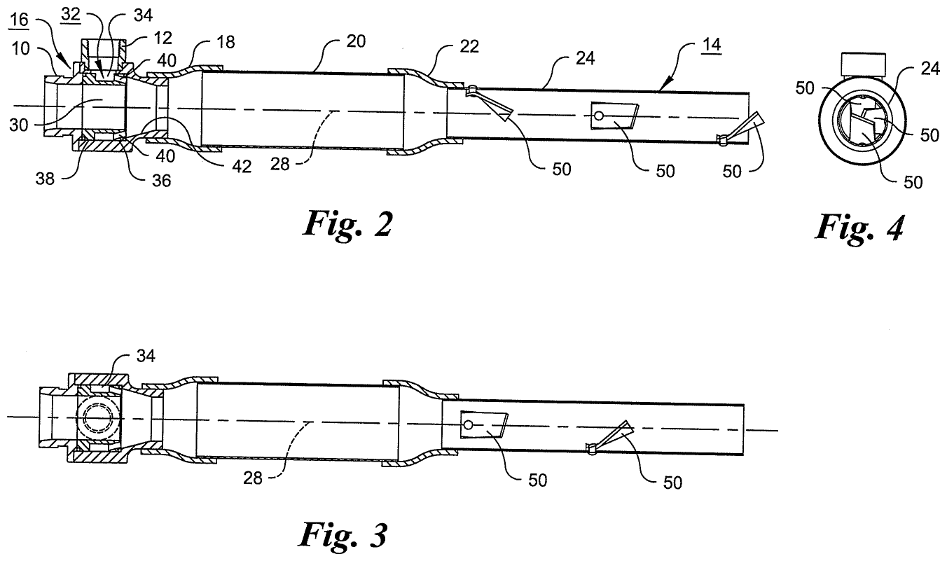

FIGS. 2 and 3 show the interior structure of the apparatus of FIG. 1. The inlet 10 directs air-entrained limestone dust along the direction of a central axis 28, and through a central opening 30 of a ring 32 inside the combining section 16. (Details of the ring 32 are shown in FIGS. 5-7.) Foam introduced through foam inlet 12 is received in an annular channel 34 formed between flanges 36 and 38 on the exterior of the ring 32. The foam flows around the ring, filling channel 34, and exits from the channel through an array of openings 40 in flange 38.

The foam and the air-entrained limestone dust come together in a tapered passage 42 in the combining section 16, and the mixture then flows through expansion section 18 into chamber 20.

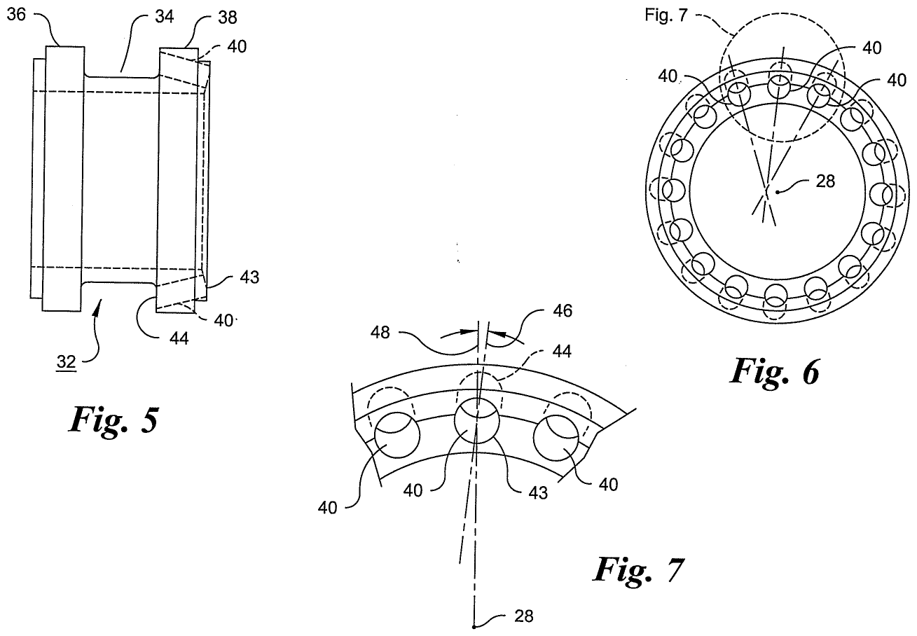

As shown in FIGS. 5, 6 and 7, the holes 40 are cylindrical and their axes are disposed at angles such that their outlet ends 43 are closer than their inlet ends 44 to the central axis 28 (FIGS. 2 and 3) of the apparatus. As shown in FIGS. 6 and 7, each of the holes 40 is formed so that its axis is directed toward one side of the central axis 28. FIG. 7 shows the relationship between a central axis 46 of one of the holes 40 and a radial plane 48 in which axis 28 lies. The axes of the other ones of holes 40 are similarly disposed in order to produce a helical flow of foam in the tapered passage 42 for more effective mixing of foam with the air-entrained limestone dust.

Mixing continues to take place in chamber 20 (FIGS. 2 and 3), and the mixture of foam, air and limestone dust then passes through reduction section 22 into the tubular section 24 of nozzle 14.

Inside the nozzle 14, a plurality of flow-interrupting baffles 50 extend inward from the inner wall of the tubular section to promote turbulence in the flow of the foam, air and limestone dust mixture through the nozzle for continued mixing. The baffles 50 can be secured to the inner wall of the tubular section 24 by rivets or other suitable fasteners, and are preferably in the form of twisted sheets of metal or synthetic resin.

Because the diameter of the passage inside the nozzle 14 is smaller than the diameter of the interior of the chamber 20, the velocity of the mixture increases as it passes from the chamber 20 into the nozzle, and the mixture can then be projected from the nozzles. The flow-interrupting baffles are preferably arranged in a helical pattern, and promote mixing, condense the stream, and shape the spray pattern of the mixture for application to a mine wall.

What is claimed is:

1. Apparatus for mixing a foam with particulate matter and air to produce a mixture, and for spraying the mixture, the apparatus comprising:
an elongated passage extending along a longitudinal axis, said passage having a first inlet opening at one end thereof, facing along the direction of said longitudinal axis, for receiving a stream of air and particulate matter passing through said first inlet opening in the direction of said longitudinal axis, and an outlet opening at an opposite end thereof for spraying said mixture;
a second inlet opening facing in a direction transverse to said longitudinal axis for receiving a stream of flowable foam directed through said second inlet opening toward said longitudinal axis; and
a ring adjacent said first inlet opening, the ring having a central opening forming a part of said elongated passage, an annular channel on the exterior of the ring, the channel being positioned to receive flowable foam passing through said second inlet opening, and a circular flange extending around the ring and forming a boundary of the annular channel on the side thereof closer to said outlet opening, said flange having passage means for the movement of flowable foam from said channel into said elongated passage for admixture with air and particulate matter passing though said central opening of the ring;
wherein said elongated passage comprises a chamber located on the side of said ring remote from said first inlet opening, and a tubular portion extending from said chamber to said outlet opening, said chamber having a maximum cross-sectional area transverse to said longitudinal axis larger than the maximum cross-sectional area of the central opening of the ring, whereby the velocity of the stream of air and particulate matter is reduced as it passes from said central opening of the ring into said chamber and more complete mixing of foam with air and particulate matter can take place in said chamber; and
wherein the cross-sectional area transverse to said longitudinal axis of at least a portion of the length of said tubular portion is smaller than said maximum cross-sectional area of said chamber, whereby the velocity of a mixture of foam, air and particulate matter through said outlet opening exceeds the maximum velocity of the mixture of foam, air and particulate matter flowing through said chamber.

2. The apparatus according to claim 1, in which the passage means of said flange comprises a plurality of circumferentially distributed through holes.

3. The apparatus according to claim 1, in which the passage means of said flange comprises a plurality of circumferentially distributed through holes, said holes being skewed in relation to said longitudinal axis in directions to cause foam exiting from said through holes to flow in a helical pattern.

4. The apparatus according to claim 1, in which the passage means of said flange comprises a plurality of circumferentially distributed through holes, each hole having an inlet end for receiving foam from said annular channel and an outlet end for delivery of foam to said chamber, said holes being skewed in relation to said longitudinal axis in directions to cause foam exiting from said through holes to flow in a helical pattern, and the outlet end of each of said holes being closer than the inlet end thereof to said axis.

5. The apparatus according to claim 1, in which said chamber includes a cylindrical tube having an inner diameter greater than the maximum dimension of said portion of the length of said tubular portion.

6. The apparatus according to claim 1, in which said tubular portion includes a plurality of flow-interrupting baffles for promoting turbulence in the flow of said mixture through said tubular portion.

7. The apparatus according to claim 1, in which said tubular portion has an inner wall and includes a plurality of flow-interrupting baffles extending inward from said inner wall for promoting turbulence in the flow of said mixture through said tubular portion.

8. The apparatus according to claim 1, in which said tubular portion has a cylindrical inner wall and includes a plurality of flow-interrupting baffles extending inward from said inner wall from locations on an imaginary helix on said cylindrical inner wall for promoting turbulence in the flow of said mixture through said tubular portion.

9. The apparatus according to claim 1, in which said tubular portion has a cylindrical inner wall and includes a plurality of flow-interrupting baffles extending inward from said inner wall from locations on an imaginary helix on said cylindrical inner wall for promoting turbulence in the flow of said mixture through said tubular portion, each of said flow-interrupting baffles being in the form of a twisted plate secured to said inner wall by a fastener, and extending obliquely from the location of said fastener toward said axis and toward said outlet opening.
